(19) United States
(12) Patent Application Publication
(10) Pub. No.: US 2025/0317002 A1
(43) Pub. Date: Oct. 9, 2025

(54) TECHNOLOGIES FOR DUAL-STAGE CHARGE COLLECTION AND ENERGY STORAGE FOR ALTERNATIVE ENERGY SOURCES

(71) Applicant: THE TEXAS A&M UNIVERSITY SYSTEM, College Station, TX (US)

(72) Inventors: Shuza BINZAID, College Station, TX (US); Kazi Meharajul KABIR, College Station, TX (US)

(21) Appl. No.: 18/866,784

(22) PCT Filed: May 15, 2023
(86) PCT No.: PCT/US2023/066994

§ 371 Date: Nov. 18, 2024

Related U.S. Application Data
(60) Provisional application No. 63/343,731, filed on May 19, 2022.

(51) Int. Cl. H02J 7/34; H02J 7/00; H02J 7/02

(52) U.S. Cl. CPC H02J 7/345; H02J 7/00309; H02J 7/0049; H02J 7/005; H02J 7/007182; H02J 7/007192; H02J 7/02; H02J 2207/20

(57) ABSTRACT

Technologies for dual-stage charge collection and energy storage include an energy storage module having a first stage energy storage device, a second stage energy storage device, and a microcontroller. The first stage energy storage device may include capacitive storage and the second stage energy storage device may include battery storage. When rectified input power is available from an unbalanced peak alternating current power signal, the microcontroller activates quick charging of the first stage energy storage device. When the first stage energy storage device is full, the microcontroller activates charging of the second stage energy storage device. When the second stage energy storage device is full, the microcontroller activates power delivery to an external load. Other embodiments are described and claimed.

### CROSS-REFERENCE TO RELATED APPLICATIONS

This application claims the benefit of and priority to U.S. Patent Application No. 63/343,731, entitled “DUAL-STAGE CHARGE COLLECTION AND ENERGY STORAGE ELECTRONIC MODULE FOR ALTERNATIVE ENERGY APPLICATION,” which was filed on May 19, 2022, which is incorporated herein by reference in its entirety.

### STATEMENT REGARDING FEDERALLY SPONSORED RESEARCH

This invention was made with Government support under Federal Grant No. 2025641, awarded by the National Science Foundation. The Government has certain rights in this invention.

### BACKGROUND

Alternative energy sources that do not generate carbon pollution are desirable for environmental or climate purposes. Many alternative energy sources generate acyclic or unbalanced peak AC or DC power signals. Typical energy storage systems such as conventional chargers for lithium-ion batteries may not be compatible with such acyclic or unbalanced signals. Other energy storage systems such as supercapacitors may have relatively low efficiency. For example, a typical supercapacitor system may quickly lose up to 50% of stored energy due to self-discharge properties.

### SUMMARY

According to one aspect of the disclosure, a method for energy storage management comprises determining, by a controller, whether input power is available from a rectifier input stage, wherein the rectifier input stage is coupled to an unbalanced peak alternating current power signal; activating, by the controller, charging of a first stage energy storage device coupled to the rectifier input stage in response to determining that input power is available; determining, by the controller, whether the first stage energy storage device is full in response to activating charging of the first stage energy storage device; and activating, by the controller, charging of a second stage energy storage device coupled to the first stage energy storage device in response to determining that the first stage energy storage device is full.

In an embodiment, the method further comprises determining, by the controller, whether the second stage energy storage device is full in response to activating charging of the second stage energy storage device; and activating, by the controller, power delivery to an external load coupled to the second stage energy storage device in response to determining that the second stage energy storage device is full. In an embodiment, determining whether the first stage energy device is full comprises comparing a voltage of the first stage energy device to a first predetermined voltage threshold. In an embodiment, determining whether the second stage energy device is full comprises comparing a voltage of the second stage energy device to a second predetermined voltage threshold, wherein the first predetermined voltage threshold is greater than the second predetermined voltage threshold. In an embodiment, the first predetermined voltage threshold comprises 18 VDC and the second predetermined voltage threshold comprises 12.6 VDC.

In an embodiment, the first stage energy storage device comprises a capacitive storage device, and the second stage energy storage device comprises a battery storage device. In an embodiment, activating charging of the first stage energy storage device charge comprises boosting voltage of the input power from the rectifier input stage. In an embodiment, activating charging of the second stage energy storage device comprises boosting current of power from the first stage energy storage device.

In an embodiment, the method further comprises determining, by the controller, whether the first stage energy storage device is healthy; wherein activating the charging of the first stage energy storage device comprises activating the charging in response to determining that the first stage energy storage device is healthy. In an embodiment, determining whether the first stage energy storage device is healthy comprises monitoring temperature or overload condition of the first stage energy storage device. In an embodiment, the method further comprises entering, by the controller, a sleep mode in response to determining that the first stage energy storage device is not healthy.

In an embodiment, the method further comprises determining, by the controller, whether the second stage energy storage device is healthy; wherein activating the charging of the second stage energy storage device comprises activating the charging in response to determining that the second stage energy storage device is healthy. In an embodiment, determining whether the second stage energy storage device is healthy comprises monitoring temperature or overload condition of the second stage energy storage device. In an embodiment, the method further comprises entering, by the controller, a sleep mode in response to determining that the second stage energy storage device is not healthy.

According to another aspect, a computing device for energy storage management comprises a quick charge manager and an energy dump manager. The quick charge manager is configured to determine whether input power is available from a rectifier input stage, wherein the rectifier input stage is coupled to an unbalanced peak alternating current power signal, and to activate charging of a first stage energy storage device coupled to the rectifier input stage in response to a determination that input power is available. The energy dump manager is configured to determine whether the first stage energy storage device is full in response to activation of charging of the first stage energy storage device, and to activate charging of a second stage energy storage device coupled to the first stage energy storage device in response to a determination that the first stage energy storage device is full.

In an embodiment, the computing device further comprises an external load manager to determine whether the second stage energy storage device is full in response to activation of charging of the second stage energy storage device; and to activate power delivery to an external load coupled to the second stage energy storage device in response to a determination that the second stage energy storage device is full. In an embodiment, to determine whether the first stage energy device is full comprises to compare a voltage of the first stage energy device to a first predetermined voltage threshold. In an embodiment, to determine whether the second stage energy device is full comprises to compare a voltage of the second stage energy device to a second predetermined voltage threshold, wherein the first predetermined voltage threshold is greater than the second predetermined voltage threshold. In an embodiment, the first predetermined voltage threshold comprises 18 VDC and the second predetermined voltage threshold comprises 12.6 VDC.

In an embodiment, the first stage energy storage device comprises a capacitive storage device, and the second stage energy storage device comprises a battery storage device. In an embodiment, to activate charging of the first stage energy storage device charge comprises to boost voltage of the input power from the rectifier input stage. In an embodiment, to activate charging of the second stage energy storage device comprises to boost current of power from the first stage energy storage device.

In an embodiment, the computing device further comprises a device health monitor to determine whether the first stage energy storage device is healthy. To activate the charging of the first stage energy storage device comprises to activate the charging in response to a determination that the first stage energy storage device is healthy. In an embodiment, to determine whether the first stage energy storage device is healthy comprises to monitor temperature or overload condition of the first stage energy storage device. In an embodiment, the device health monitor is further to enter a sleep mode in response to a determination that the first stage energy storage device is not healthy.

In an embodiment, the computing device further comprises a device health monitor to determine whether the second stage energy storage device is healthy. To activate the charging of the first stage energy storage device comprises to activate the charging in response to a determination that the first stage energy storage device is healthy. In an embodiment, to determine whether the first stage energy storage device is healthy comprises to monitor temperature or overload condition of the first stage energy storage device. In an embodiment, the device health monitor is further to enter a sleep mode in response to a determination that the second stage energy storage device is not healthy.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for dual-stage energy storage for alternative energy sources;

FIG. 2 is a simplified block diagram of at least one embodiment of an environment that may be established by a controller of the system of FIG. 1;

FIG. 3 is a simplified flow diagram of at least one embodiment of a method for dual-stage energy storage that may be executed by the controller of FIGS. 1 and 2; and

FIG. 4 is a chart illustrating storage voltages that may be used with the system of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

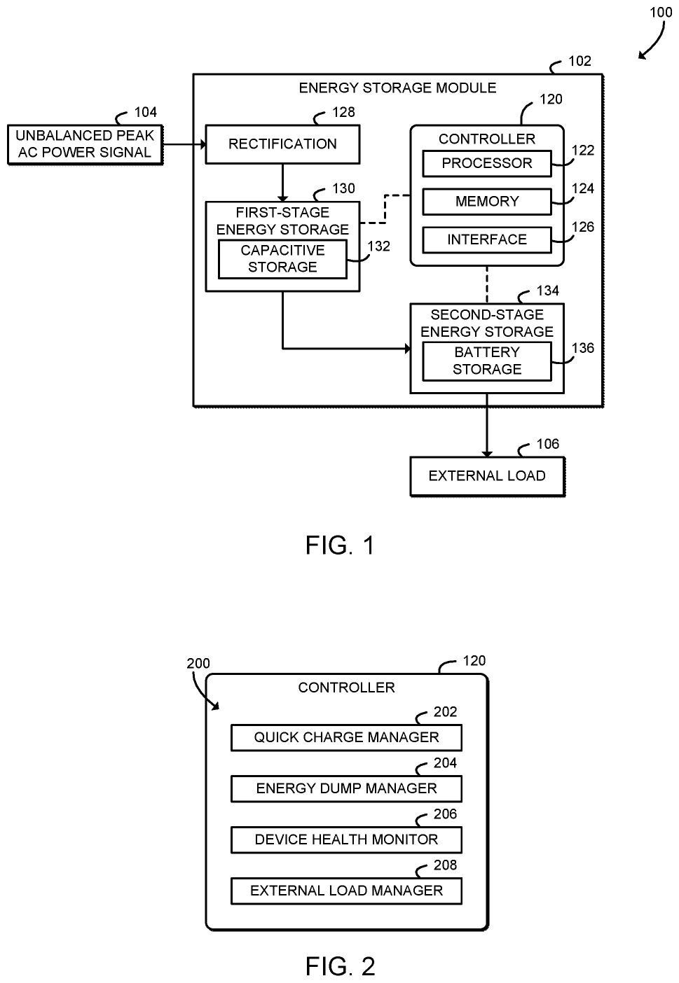

Referring now to FIG. 1, an illustrative system 100 for dual-stage charging includes an energy storage module 102 coupled to an unbalanced peak alternating current (AC) power signal 104 and an external load 106. The unbalanced peak AC power signal 104 may be generated by an alternative energy source such as a mechanical force harvesting energy device, a solar panel, a wind turbine, or other energy source that generates acyclic or unbalanced electrical energy. The external load 106 may be a power grid, microgrid, vehicle charging station, appliance, or any other external electrical load. In use, as described further below, the energy storage module 102 stores energy from the power signal 104 using a quick-charging first stage energy storage device with boosted storage voltage and a slower-charging second stage energy storage device with boosted storage current. The energy storage module 102 monitors device health and charge levels, and when the storage devices are sufficiently charged, powers the external load 106. Accordingly, the energy storage module 102 allows for efficient storage of energy generated by alternative energy sources. In contrast to conventional battery charging systems, the energy storage module 102 may be used with acyclic or unbalanced peak power sources. Further, in contrast to conventional supercapacitor systems, the energy storage module 102 may have higher efficiency for long-term storage. For example, in an experiment, an illustrative embodiment of the energy storage module 102 was found to have overall efficiency between 92-96%.

As shown in FIG. 1, the energy storage module 102 includes a controller 120, a rectification subsystem 128, a first stage energy storage device 130, and a second stage energy storage device 134. The controller 120 may be illustratively embodied as any microcontroller, microprocessor, programmable logic controller, or other device capable of performing the functions described herein. To do so, the controller 120 may include a number of electronic components commonly associated with units utilized in the control of electronic and electromechanical systems. For example, the controller 120 may include, among other components customarily included in such devices, a processor 122 and a memory device 124. The processor 122 may be any type of device capable of executing software or firmware, such as a microcontroller, microprocessor, digital signal processor, or the like. The memory 124 may be embodied as one or more volatile and/or non-volatile memory device. The memory device 124 is provided to store, amongst other things, instructions in the form of, for example, a software routine (or routines) which, when executed by the processor 122, allows the controller 120 to process signals received from the sensor device 102 described herein. The controller 120 also includes an interface circuit 126, which may be embodied as any analog and/or digital electrical circuit(s), component, or collection of components capable of performing the functions described herein. The interface circuit 126 converts output signals (e.g., from the rectification module 128, the first stage energy storage 130, and/or the second stage energy storage 134) into signals which are suitable for presentation to an input of the processor 122. In particular, in some embodiments the interface circuit 126, by an analog-to-digital (A/D) converter, or the like, converts analog signals into digital signals for use by the processor 122. Similarly, the interface circuit 126 may convert signals from the processor 122 into output signals which are suitable for presentation to other components of the system 100. It is contemplated that, in some embodiments, the interface circuit 126 (or portions thereof) may be integrated into the processor 122.

The rectification module 128 may be embodied as or include a full-wave rectifier or other rectification circuit configured to convert the unbalanced peak AC power signal 104 into a direct current (DC) signal. In an embodiment, the rectification module 128 may output voltage in a relatively high range between about 60 VDC and 130 VDC. Rectification efficiency may be around 94%.

The first stage energy storage device 130 may be embodied as an electrical energy storage device that supports rapid charging to a relatively high voltage level. Illustratively, the first stage energy storage device 130 includes capacitive storage 132. The illustrative first stage energy storage device 130 may receive energy from the rectification module 128 and quickly reach an output voltage, which may be about 18 VDC. This output voltage is not fixed and may change to be more or less depending on the supplied energy sources and capacity of the storage systems.

The second stage energy storage device 134 may be embodied as an electrical energy storage device that supports long-duration energy storage with a higher capacity as compared to the first stage energy storage device 130. Illustratively, the second stage energy storage device 134 includes battery storage 136, which may include one or more lithium-ion batteries or batteries of other chemistry. The first stage energy storage device 130 dumps energy to the second stage energy storage device 134, for example through one or more MOSFETs or other low-loss transistors with a floating ground. The second stage energy storage device 134 may be charged up to a reference voltage, which may be as high as 12.6 VDC or as low as 6 VDC. Those reference voltages are not fixed and may be adjusted by the controller 120.

Referring now to FIG. 2, in the illustrative embodiment, the controller 120 establishes an environment 200 during operation. The illustrative environment 200 includes a quick charge manager 202, an energy dump manager 204, a device health monitor 206, and an external load manager 208. The various components of the environment 200 may be embodied as hardware, firmware, software, or a combination thereof. As such, in some embodiments, one or more of the components of the environment 200 may be embodied as circuitry or a collection of electrical devices (e.g., quick charge circuitry 202, energy dump circuitry 204, device health circuitry 206, and/or external load circuitry 208). It should be appreciated that, in such embodiments, one or more of those components may form a portion of the processor 122, the memory 124, the interface 126, and/or other components of the controller 120.

The quick charge manager 202 is configured to determine whether input power is available from a rectifier input stage such as the rectification module 128. The rectifier input stage is coupled to an unbalanced peak alternating current power signal 104. The quick charge manager 202 is further configured to activate charging of the first stage energy storage device 130 coupled to the rectifier input stage in response to determining that input power is available. Activating charging of the first stage energy storage device 130 may include boosting voltage of the input power from the rectifier input stage.

The energy dump manager 204 is configured to determine whether the first stage energy storage device 130 is full, for example by comparing a voltage of the first stage energy device 130 to a predetermined voltage threshold. This predetermined voltage threshold may be, for example, 18 VDC. In response to determining the first stage energy storage device 130 is full, the energy dump manager 204 is further configured to activate charging of the second stage energy storage device 134 coupled to the first stage energy storage device 130. Activating charging of the second stage energy storage device 134 may include boosting current of power from the first stage energy storage device 130.

The external load manager 208 is configured to determine whether the second stage energy storage device 134 is full, for example by compare a voltage of the second stage energy device 134 to another predetermined voltage threshold. This predetermined voltage threshold may be, for example, 12.6 VDC, which is lower than the voltage threshold associated with the first stage energy storage device 130. In response to determining that the second stage energy storage device 134 is full, the external load manager 208 is further configured to activate power delivery to the external load 106 coupled to the second stage energy storage device 134.

The device health monitor 206 is configured to determine whether the first stage energy storage device 130 and/or the second energy storage device 134 is healthy. Charging of each energy storage device 130, 134 may be active in response to determining that the respective energy storage device 130, 134 is healthy. Determining whether an energy storage device 130, 134 is healthy may include monitoring temperature or overload condition of the respective energy storage device 130, 134. The device health monitor 206 may be further configured to cause the energy storage module 102 (e.g., the controller 120 and/or other components of the energy storage module 102) to enter a sleep mode in response to determining that either of the first stage energy storage device 130 and/or the second stage energy storage device 134 is not healthy.

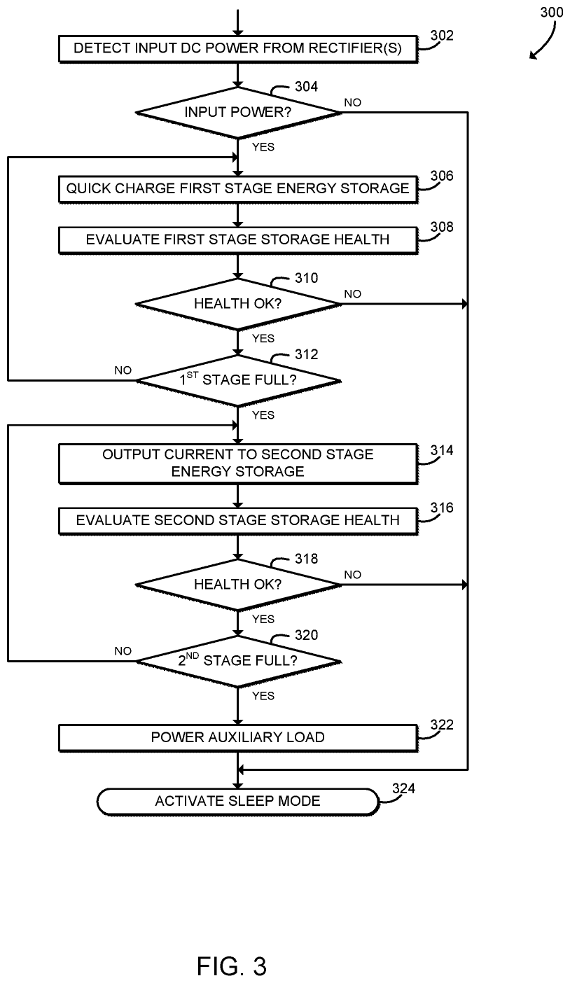

Referring now to FIG. 3, in use, the controller 120 may execute a method 300 for dual-stage energy storage. It should be appreciated that, in some embodiments, the operations of the method 300 may be performed by one or more components of the environment 200 of the controller 120 as shown in FIG. 2. The method 300 begins with block 302, in which the controller 120 detects whether input DC power is generated by the rectification module 128. The rectification module 128 may include one or more full-wave rectifiers or other DC rectification circuits. The rectification module 128 may generate DC power when power is available from the unbalanced peak AC power signal 104. The DC power generated by the rectification module 128 may be acyclic or otherwise intermediate and may have relatively high peak voltages (e.g., between 60-130 VDC).

In block 304, the controller 120 checks whether input DC power is generated by the rectification module 128. If not, the method 300 branches ahead to block 324, in which the controller 120 activates sleep mode. In sleep mode, the controller 120 and/or other components of the energy storage module 102 may enter a low-power mode or otherwise be deactivated. After activating sleep mode, the method 300 is completed. The method 300 may be executed again, for example, periodically (e.g., in response to a timer interrupt), responsively (e.g., in response to voltage changes) or otherwise executed multiple times to control operation of the energy storage module 102.

Referring again to block 304, if input DC power is detected, the method 300 advances to block 306, in which the controller 120 activates quick charging of the first stage energy storage device 130. For example, the input DC power may be supplied to the capacitive storage device 132 of the first stage energy storage device 130. For faster charging, voltage of the input DC power may be boosted or otherwise relatively high-voltage power may be used to charge the first stage energy storage device 130. In an embodiment, the first stage energy storage device 130 may deliver voltage at 18 VDC. In some embodiments, the delivery voltage may not be fixed, and may change depending on supplied energy sources and the capacity of the first stage energy storage device 130.

In block 308, the controller 120 evaluates the health of the first stage energy storage device 130. For example, the controller 120 may determine whether the temperature, voltage, or other parameters of the first stage energy storage device 130 are within predetermined bounds or otherwise indicate that the first stage energy storage device 130 is healthy. In block 310, the controller 120 checks whether the first stage energy storage device 130 is healthy. If not, the method 300 branches ahead to block 324, in which the controller 120 activates sleep mode. As described above, in sleep mode, the controller 120 and/or other components of the energy storage module 102 may enter a low-power mode or otherwise be deactivated. In addition, in some embodiments the first stage energy storage device 130 may be deactivated, may enter a safe mode, or may otherwise be configured to protect device health. Referring again to block 310, if the controller 120 determines that the first stage energy storage device 130 is healthy, the method 300 advances to block 312.

In block 312, the controller 120 determines whether the first stage storage device 130 is full. For example, the controller 120 may compare the current voltage of the first stage storage device 130 to a predetermined threshold, such as 18 VDC. If the first stage storage device 130 is not full, the method 300 loops back to block 306 to continue quick-charging the first stage storage device 130. If the first stage storage device 130 is full, the method 300 advances to block 314.

In block 314, the controller 120 outputs current from the first stage energy storage device 130 to charge the second stage energy storage device 134. For example, current may be output from the capacitive storage 132 supplied to the battery storage 136. Power may be supplied to the second stage energy storage device 134 at relatively lower voltage and higher current as compared to the first stage energy storage device 130. For example, in an embodiment output voltage for the second stage energy storage device 134 may be 12.6 VDC. In other embodiments, output voltage may be set high at 12.6 VDC and low at 6 VDC. In some embodiments, those settings may be changeable and reprogrammable, for example in the controller 120. In an embodiment, power may be supplied to the second stage energy storage device 134 using one or more MOSFETs operating in saturation mode and coupled to a floating ground. Thus, relatively higher voltage of the first stage energy storage device 130 may be supplied to the second stage energy storage device 134 without exceeding voltage limits and without DC voltage conversion. This technique for providing energy may reduce energy losses or otherwise improve efficiency.

In block 316, the controller 120 evaluates the health of the second stage energy storage device 134. For example, the controller 120 may determine whether the temperature, voltage, or other parameters of the second stage energy storage device 134 are within predetermined bounds or otherwise indicate that the second stage energy storage device 134 is healthy. In block 318, the controller 120 checks whether the second stage energy storage device 134 is healthy. If not, the method 300 branches ahead to block 324, in which the controller 120 activates sleep mode. As described above, in sleep mode, the controller 120 and/or other components of the energy storage module 102 may enter a low-power mode or otherwise be deactivated. In addition, in some embodiments the second stage energy storage device 134 may be deactivated, may enter a safe mode, or may otherwise be configured to protect device health. Referring again to block 318, if the controller 120 determines that the second stage energy storage device 134 is healthy, the method 300 advances to block 320.

In block 320, the controller 120 determines whether the second stage storage device 134 is full. For example, the controller 120 may compare the current voltage of the second stage storage device 134 to a predetermined threshold, such as 12.6 VDC. If the second stage storage device 134 is not full, the method 300 loops back to block 314 to continue charging the second stage storage device 134. If the second stage storage device 134 is full, the method 300 advances to block 322.

In block 322, the controller 120 outputs power from the second stage energy storage device 134 to the external load 106. For example, the battery storage 136 may output power to the external load 106. As described above, the external load 106 may be a power grid, microgrid, vehicle charging station, appliance, or any other external electrical load. Power may be output as DC electrical power at a predetermined output voltage, such as 12.6 VDC. The controller 120 may activate power to the external load 106 when both energy storage devices 130, 134 are fully charged and within acceptable operating limits. Energy may continue to flow from the unbalanced peak AC power signal 104 to the energy storage module 102 while the external load 106 receives power. After powering the external load 106, the method 300 advances to block 324, in which the controller 120 activates sleep mode. As described above, in sleep mode, the controller 120 and/or other components of the energy storage module 102 may enter a low-power mode or otherwise be deactivated. Power may continue to be delivered while the controller 120 is in sleep mode, and the controller 120 may periodically, responsively, or otherwise wake from the sleep mode to continue executing the method 300.

Although illustrated as being performed sequentially, it should be understood that in some embodiments, the operations of the method 300 may be performed in parallel, in a different order, or otherwise in a different arrangement. For example, as described above, in an embodiment power may continue to be supplied to the first stage energy storage device 130 and/or to the second stage energy storage device 134 while power is provided to the external load 106.

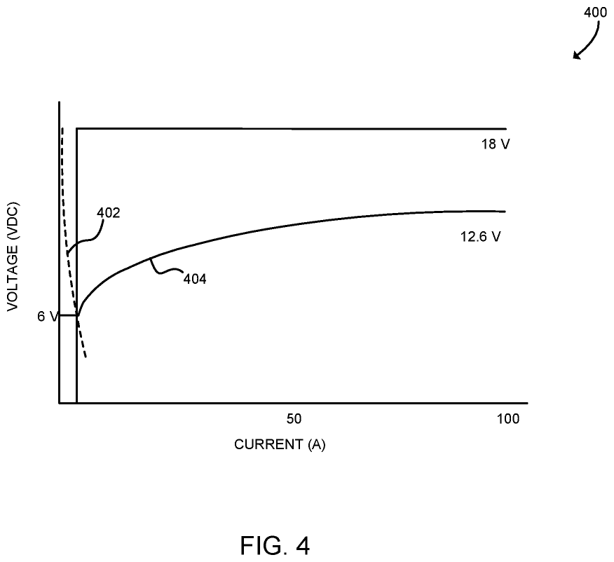

Referring now to FIG. 4, diagram 400 illustrates output voltage for the energy storage module 102 during operation. Curve 402 illustrates output voltage of the first stage energy storage device 130 (e.g., the capacitive storage 132). Curve 404 illustrates output voltage of the second stage energy storage device 134 (e.g., the battery storage 136). As shown, the first stage energy storage device 130 almost immediately reaches its output voltage of 18 VDC when supplied with power from the unbalanced peak AC power signal 104. After reaching that output voltage, current is dumped from the first stage energy storage device 130 into the second stage energy storage device 134. The second stage energy storage device 130 more gradually increases voltage from its minimum voltage of 6 VDC toward its maximum output voltage of 12.6 VDC. Once the output voltage of the second stage energy storage device 134 reaches this maximum output voltage, power may be delivered to the external load 106 as described above.

1. A method for energy storage management, the method comprising:
determining, by a controller, whether input power is available from a rectifier input stage, wherein the rectifier input stage is coupled to an unbalanced peak alternating current power signal;
activating, by the controller, charging of a first stage energy storage device coupled to the rectifier input stage in response to determining that input power is available;
determining, by the controller, whether the first stage energy storage device is full in response to activating charging of the first stage energy storage device; and
activating, by the controller, charging of a second stage energy storage device coupled to the first stage energy storage device in response to determining that the first stage energy storage device is full.

2. The method of claim 1, further comprising:
determining, by the controller, whether the second stage energy storage device is full in response to activating charging of the second stage energy storage device; and
activating, by the controller, power delivery to an external load coupled to the second stage energy storage device in response to determining that the second stage energy storage device is full.

3. The method of claim 2, wherein determining whether the first stage energy device is full comprises comparing a voltage of the first stage energy device to a first predetermined voltage threshold.

4. The method of claim 3, wherein determining whether the second stage energy device is full comprises comparing a voltage of the second stage energy device to a second predetermined voltage threshold, wherein the first predetermined voltage threshold is greater than the second predetermined voltage threshold.

5. The method of claim 4, wherein the first predetermined voltage threshold comprises 18 VDC and the second predetermined voltage threshold comprises 12.6 VDC.

6. The method of claim 1, wherein the first stage energy storage device comprises a capacitive storage device, and the second stage energy storage device comprises a battery storage device.

7. The method of claim 1, wherein activating charging of the first stage energy storage device charge comprises boosting voltage of the input power from the rectifier input stage.

8. The method of charge 1, wherein activating charging of the second stage energy storage device comprises boosting current of power from the first stage energy storage device.

9. The method of claim 1, further comprising determining, by the controller, whether the first stage energy storage device is healthy;
wherein activating the charging of the first stage energy storage device comprises activating the charging in response to determining that the first stage energy storage device is healthy.

10. The method of claim 9, wherein determining whether the first stage energy storage device is healthy comprises monitoring temperature or overload condition of the first stage energy storage device.

11. The method of claim 9, further comprising entering, by the controller, a sleep mode in response to determining that the first stage energy storage device is not healthy.

12. The method of claim 1, further comprising determining, by the controller, whether the second stage energy storage device is healthy;
wherein activating the charging of the second stage energy storage device comprises activating the charging in response to determining that the second stage energy storage device is healthy.

13. The method of claim 12, wherein determining whether the second stage energy storage device is healthy comprises monitoring temperature or overload condition of the second stage energy storage device.

14. The method of claim 12, further comprising entering, by the controller, a sleep mode in response to determining that the second stage energy storage device is not healthy.

15. A computing device for energy storage management, the computing device comprising:
a quick charge manager to (i) determine whether input power is available from a rectifier input stage, wherein the rectifier input stage is coupled to an unbalanced peak alternating current power signal, and (ii) activate charging of a first stage energy storage device coupled to the rectifier input stage in response to a determination that input power is available; and
an energy dump manager to (i) determine whether the first stage energy storage device is full in response to activation of charging of the first stage energy storage device, and (ii) activate charging of a second stage energy storage device coupled to the first stage energy storage device in response to a determination that the first stage energy storage device is full.

16. The computing device of claim 15, further comprising an external load manager to:
determine whether the second stage energy storage device is full in response to activation of charging of the second stage energy storage device; and
activate power delivery to an external load coupled to the second stage energy storage device in response to a determination that the second stage energy storage device is full.

17. The computing device of claim 16, wherein to determine whether the first stage energy device is full comprises to compare a voltage of the first stage energy device to a first predetermined voltage threshold.

18. The computing device of claim 17, wherein to determine whether the second stage energy device is full comprises to compare a voltage of the second stage energy device to a second predetermined voltage threshold, wherein the first predetermined voltage threshold is greater than the second predetermined voltage threshold.

19. The computing device of claim 18, wherein the first predetermined voltage threshold comprises 18 VDC and the second predetermined voltage threshold comprises 12.6 VDC.

20. The computing device of claim 15, wherein the first stage energy storage device comprises a capacitive storage device, and the second stage energy storage device comprises a battery storage device.

21.-31. (canceled)
